(19) United States
(12) Patent Application Publication
(10) Pub. No.: US 2023/0216729 A1
(43) Pub. Date: Jul. 6, 2023

(54) MANAGEMENT SYSTEM AND CONTROL METHOD THEREOF FOR BATTERY MANAGEMENT SYSTEM

(71) Applicants: SK ON CO., LTD., Seoul (KR); AUTOSILICON INC., Seoul (KR)

(72) Inventors: Jae Hee LEE, Daejeon (KR); Woo Jung KIM, Daejeon (KR); Ki Man LA, Daejeon (KR); Sang Hae PARK, Daejeon (KR); Jeong Min SEO, Daejeon (KR); Ki Bum SUNG, Daejeon (KR); Ho Sang JANG, Daejeon (KR); Dong Hyeon KIM, Daejeon (KR); Ji Hun KIM, Daejeon (KR); Myoung Su SONG, Seoul (KR)

(21) Appl. No.: 18/085,195

(22) Filed: Dec. 20, 2022

(30) Foreign Application Priority Data
Dec. 30, 2021 (KR) 10-2021-0192347

(51) Int. Cl. H04L 41/0681; H04L 5/16

(52) U.S. Cl. CPC H04L 41/0681; H04L 5/16

(57) ABSTRACT

A management system and a control method are disclosed to transmit/share fault state information immediately without constructing a separate communication path for transmitting fault state information.

### CROSS-REFERENCE TO RELATED APPLICATIONS

This patent document claims priority under 35 U.S.C. § 119 to Korean Patent Application No. 10-2021-0192347, filed on Dec. 30, 2021, in the Korean Intellectual Property Office, the disclosure of which is incorporated herein by reference in its entirety.

### TECHNICAL FIELD

The disclosure of this patent document relates to a management system applicable to a battery management system and a control method thereof.

### BACKGROUND

In various conventional communication networks configured in a ring structure and operating in a half-duplex transmission mode, communication can be made between a main module and a sub-module according to a mode for either transmission or reception set by the main module. When a network fault, a sub-module fault, or the like occurs in such systems, there may be a problem in that the sub-module may not transmit desired fault information to the main module until a current transmission mode is changed to a reception mode.

Therefore, since the main module has all control rights due to characteristics of the communication network (a slave can respond only when a master gives a command), the communication network (daisy chain communication network) configured in the ring structure and operating in the half-duplex transmission mode may not actively and quickly transmit the detected fault information to the main module even if a fault is detected by the sub-module connected to the main module.

### SUMMARY

One possible solution to address the above problem is to provide a separate auxiliary communication line for quickly transmitting the fault information so that the fault information is independently transmitted when the fault occurs. However, in implementing this separate auxiliary communication line, when the separate auxiliary communication line for transmitting the fault information is constructed in order to secure a safety rating of a system, it may inevitable increase manufacturing costs of the system as well as increase the weight and manufacturing costs of the entire system.

FIG. 1 shows an example of a conventional communication network configured in the ring structure and operating in the half-duplex transmission mode. In this example, since the active fault information transmission in the module is impossible through a main communication path due to the characteristics of the half-duplex transmission mode, it is necessary to construct a separate fault communication path for quick fault response.

As a result, as illustrated in FIG. 2, any selected network direction is set as a main communication direction, and when a fault occurs, the fault information is transmitted through a communication channel separately constructed for the fault communication path. Thereafter, the communication safety is secured by configuring the communication network by changing the setting of the main communication direction as a countermeasure against the fault.

The disclosure in this patent document relates to a technology for a management system that can be configured in a ring structure and operate in a half-duplex transmission mode to actively transmit fault information when a fault occurs without constructing a separate fault communication channel and respond promptly accordingly, thereby securing safety without increasing costs to improve or maintain the safety of the system, and a control method thereof.

An embodiment of the present disclosure is directed to providing a management system applicable to a battery management system and the like and a control method thereof, and provides a management system and a control method thereof capable of improving safety of the system by actively and quickly transmitting fault information to a main module without constructing a separate communication path for main fault information related to safety diagnosis.

In one general aspect, a management system may include: first to N-th sub-modules that are a plurality of sub-modules for monitoring states of a plurality of targeted objects, respectively; and a main module connected to the first to N-th sub-modules to receive state information of the targeted object, in which the main module and the first to N-th sub-modules may be sequentially connected through a half-duplex communication network having a ring structure, the main module may sequentially transmit information to the first to N-th sub-modules through the network in a first direction, and the main module may receive information from at least any one of the first to N-th sub-modules through the network in a second direction opposite to the first direction, and when an abnormal state is detected during monitoring, the i-th sub-module may be switched to a fault transmission mode, and transmit fault information to the main module through the network without waiting until a network transmission direction is changed to the second direction under control of the main module: (N>1, N≥i≥1).

The i-th sub-module may determine a current communication state in a case of the fault transmission mode, and hold a current communication operation when the determined current communication state is a reception mode (RX).

The i-th sub-module may hold the current communication operation and then transmit the fault information to the main module through the network in the first direction.

The i-th sub-module may complete the transmission of the fault information to the main module and then return the held current communication operation.

When the determined current communication state is the transmission mode (TX), the i-th sub-module may wait for a change to the reception mode (RX) while maintaining the current communication operation.

When receiving the fault information from the i-th sub-module, the main module may transmit a command signal requesting current state information for the connected first to N-th sub-modules through the network in the first direction.

In another general aspect, a control method of a management system configured in a ring structure and operating in a half-duplex transmission mode, including one main module and first to N-th sub-modules as a plurality of sub-modules may include: a monitoring step of monitoring states of connected targeted objects, respectively, in the first to N-th sub-modules; a state determination step of determining a current communication state when an abnormal state is detected during monitoring by the monitoring step in an i-th sub-module; a reception holding step of holding a current communication operation according to the determination result of the state determination step in the i-th sub-module, when the current communication state is a reception mode (RX); a fault transmission step of transmitting fault information detected by the monitoring step through a network in a first direction between the main module and the plurality of sub-modules in the i-th sub-module; and a holding release step of returning the current communication operation held by the reception holding step in the i-th sub-module. (N>1, N≥i≥1).

The control method may further include: before performing the monitoring step, an activation step of activating an active fault signaling (AFS) function in the i-th sub-module.

The control method may further include: after performing the state determination step, a holding waiting step of waiting for a change to a reception mode while maintaining a current communication operation according to the determination result of the state determination step in the i-th sub-module, when the current communication state is a transmission mode (TX).

Before holding the current communication operation through the reception holding step, when a command signal is received from the main module, the current communication operation may be held after performing a response operation according to the received command signal while maintaining the current communication operation.

Before holding the current communication operation through the reception holding step, when a signal is received from another i-th sub-module, the current communication operation may be held after performing a transmission operation according to the received signal while maintaining the current communication operation.

When abnormal states of targeted objects connected in two or more sub-modules, respectively, are detected in the monitoring step, in each sub-module, the state determination step, the reception holding step, the fault transmission step, and the holding release step may be performed by control, but, in the main module, fault information of a sub-module closest to the main module may be received based on a communication direction mode in which the fault information is transmitted by the fault transmission step.

The control method may further include: after performing the fault transmission step, a fault detection step of transmitting a command signal requesting current state information for the connected first to N-th sub-modules in the main module when the fault information is received from the i-th sub-module by the fault transmission step.

### BRIEF DESCRIPTION OF THE DRAWINGS

FIG. 1 is an exemplary configuration diagram of a conventional communication network configured in a ring structure and operating in a half-duplex transmission mode.

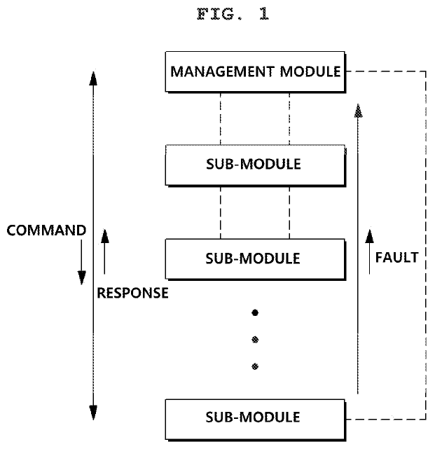

FIG. 2 is an exemplary diagram illustrating a communication path configured to transmit fault state information in the event of fault during the operation of the conventional communication network illustrated in FIG. 1.

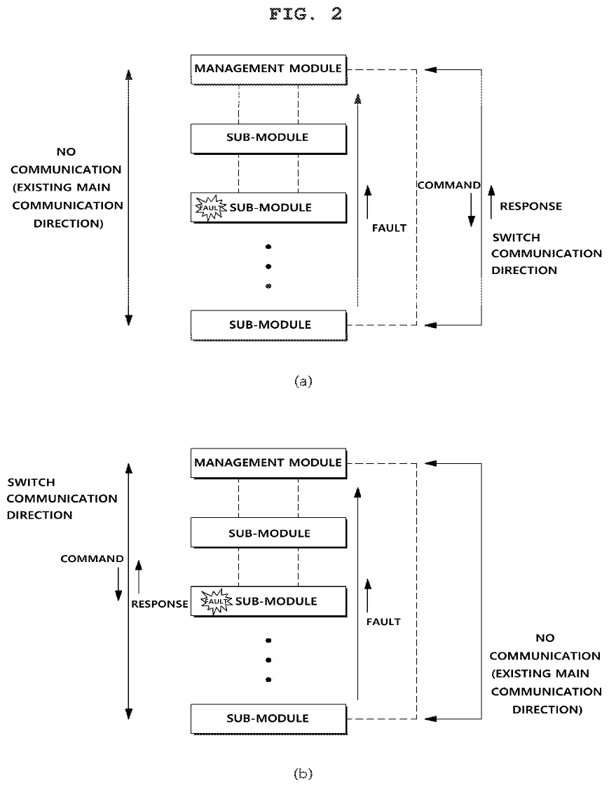

FIG. 3 is an exemplary configuration diagram illustrating the configuration of a communication network configured in a ring structure and operating in a half-duplex transmission mode by a communication network management system and a control method thereof according to an embodiment of the present disclosure.

FIG. 4 is an exemplary diagram illustrating a communication path configured to transmit fault state information when a fault occurs during an operation of a communication network by a communication network management system and a control method thereof according to an embodiment of the present disclosure.

FIG. 5 is a flowchart illustrating a communication network control method according to an embodiment of the present disclosure.

### DETAILED DESCRIPTION OF EMBODIMENTS

In the case of the conventional communication network configured in a ring structure and operating in a half-duplex transmission mode, since the management system has a structure in which it is difficult to quickly transmit information from a slave module to a master module when necessary, the management system operates so that a separate communication channel is additionally constructed to cause a slave module to quickly transmit necessary information to a master module when necessary. In this case, there is a problem in that it is inevitable to incur additional costs for constructing a separate communication channel.

In order to solve this problem, a management system applicable to a battery management system and the like and a control method thereof according to an embodiment of the present disclosure perform a control operation to cause a slave module to quickly transmit necessary information to a master module when necessary without additionally constructing a separate communication channel in a communication network configured in a ring structure and operating in a half-duplex transmission mode.

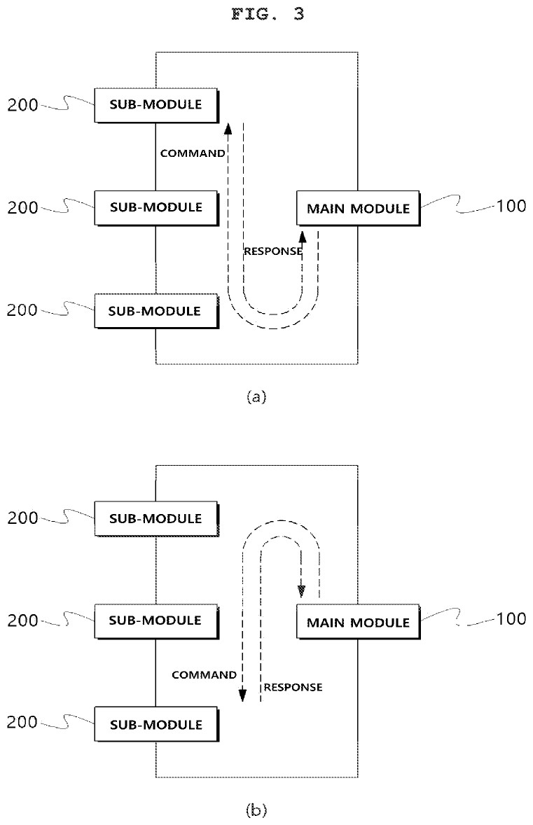

As illustrated in FIG. 3, since the management system operates in a half-duplex transmission mode configured in a ring structure, normally, a master module, that is, a main module 100 has a control right for the constructed communication channel, sub-modules 200 transmit a response signal using a network in a second direction opposite to a first direction according to a command signal of the main module 100 transmitted through the network in the first direction.

In detail, in normal times, as illustrated in FIG. 3A, the main module 100 transmits the command signal clockwise using the constructed communication channel, and the sub-module 200 transmits a response signal to the command signal counterclockwise, or as illustrated in FIG. 3B, the main module 100 transmits the command signal to the sub-module 200 counterclockwise and the sub-module 200 transmits the response signal to the command signal clockwise.

Therefore, as described above, even if an abnormality of a targeted object being monitored in any one of the sub-modules 200 is detected, the sub-module 200 does not have the communication control right of the currently constructed communication channel, it is difficult to quickly transmit the detected abnormality to the main module 100.

Accordingly, in the related art, a separate communication channel is configured only for the fault, transmission, and when the abnormality is detected, the corresponding sub-module 200 has the control right of the fault communication channel and transmits a fault signal to the main module 100. However, in this case, naturally, many difficulties and inconveniences arise in a process of constructing a separate communication channel in addition to the existing communication channel.

Accordingly, as illustrated in FIG, 4, in the communication network control system according to the embodiment of the present disclosure, when an abnormality is detected by at least one sub-module 200, a communication control right is temporarily assigned to the sub-module 200, not to the main module 100, so the sub-module 200 quickly transmits fault information to the main module 100 through a receiving direction without waiting until a network direction is changed to a receiving direction by the main module 100.

As a result, since a fault detection time interval (FDTI) is minimized, a fault reaction time interval (FRTI) may be maximally secured based on a fault tolerant time interval (FTTI) (FTTI>FDTI+FRTI) in order to secure function safety of a system, and thus, the master module may improve the safety of the system.

In this case, for a smooth understanding, the description is limited to a battery management system (BMS), which is only an embodiment, and the present disclosure can be applied to communication network that needs to actively and immediately transmit information such as various faults from the slave module to the master module.

Next, for example, the main module 100 is a battery monitoring unit (BMU), and preferably configured of a micro controller unit (MCU) and an interface IC (IFIC), and the sub-module 200 includes a cell monitoring unit (CMU) and a battery. In this case, the CMU includes a battery monitoring IC (BMIC) and a filter. The main module communicates with the BMICs of each sub-module through the IFIC. To this end, the IFIC and the BMICs are connected in a daisy chain structure.

In detail, the main module 100 receives states of targeted objects being monitored from each of the first to N-th sub-modules which are the plurality of sub-modules 200 connected to the network.

In addition, the sub-module 200 monitors the states of each of the plurality of targeted objects.

It is preferable that the main module 100 and the first to Nth sub-modules 200 are sequentially connected by a half-duplex communication network having a ring structure. In normal times, by using the communication control right set in the main module 100, the main module 100 sequentially transmits desired information (command information, etc.) to the first to N-th sub-modules 200 through the network in the first direction. In addition, the main module 200 receives information (response information) from at least one of the first to N-th sub-modules 200 through the network in the second direction opposite to the first direction (where, N>1).

However, when a problem occurs in the i-th sub-module 200, that is, when an abnormal state of the targeted object detected by any of the sub-modules 200 is detected, the sub-module 200 is quickly switched to the fault transmission mode, and thus, the corresponding sub-module 200 temporarily has the communication control right of the current network communication direction without waiting until the main module 100 changes the network communication direction to quickly transmit the fault information (abnormality detection information, etc.) to the main module 100 (where, N≥i≥1). To this end, the plurality of sub-modules 200 monitor the operating states (main fault information related to safety diagnosis) of the connected targeted objects, respectively, but when a fault is detected, the plurality of sub-modules perform the operation in the fault transmission mode.

In this case, when the targeted object is limited to a battery as described above, as the operating states monitored by the sub-module 200, over voltage (OV), under voltage (UV), over temperature (OT), under temperature (UT), or internal fault information of the sub-module may be described as a result, but the present disclosure is not limited thereto.

When the sub-module 200 is switched to the fault transmission mode, the sub-module 200 quickly performs an operation without waiting until the main module 100 changes the network transmission direction.

In detail, the current communication state of the i-th sub-module 200 is determined in the i-th sub-module 200 switched to the fault transmission mode. That is, it is preferable to determine whether the current communication state is a transmission mode (TX) or a reception mode (RX).

Through this, when the determined current communication state is the reception mode, the current communication operation is held, that is, signals from the connected main module 100 or other sub-modules 200 are blocked from being received.

When the determined current communication state is the transmission mode, the change to the reception mode while maintaining the current communication operation waits. That is, after all the transmission is completed, the current communication operation is held after waiting until the current communication operation is changed to the reception mode.

After holding the current communication operation in this way, the i-th sub-module 200 transmits the detected fault information to the main module 100 based on the temporary control right set for the current communication direction.

That is, the i-th sub-module 200 may receive information from the main module 100 in the first direction only under the control of the main module 100, and transmit the information to the main module 100 in the second direction opposite to the first direction, but when the i-th sub-module 200 is switched to the fault transmission mode, the i-th sub-module 200 transmits the fault information detected by the main module 100 through the first direction without waiting until the i-th sub-module 200 is changed to the second direction.

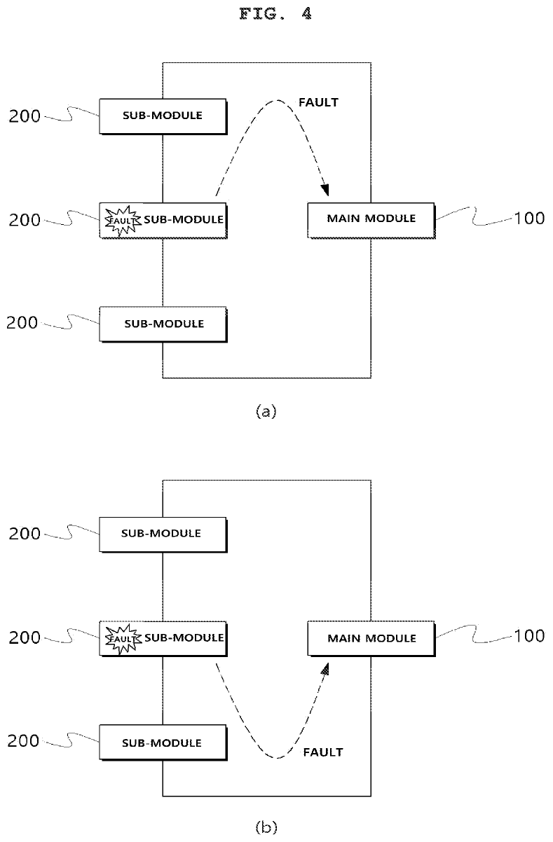

In other words, as illustrated in FIG. 4, in the i-th sub-module 200 switched to the fault transmission mode, the main module 100 has the control right, and thus, transmits the fault information using the first direction in which the command information is transmitted, so the main module 100 receives the fault information. When the i-th sub-module 200 transmits the fault information using the second direction instead of the first direction, the fault information may conflict with the command signal from the main module 100, so that the main module 100 has the control right and transmits the fault information using the first direction in which the command information is transmitted.

Thereafter, it is preferable that the i-th sub-module 200 returns the held current communication operation after the transmission of the fault information is completed.

As a result, the i-th sub-module 200 may immediately notify the main module 100 of the fault information using the current main communication direction as soon as the fault is detected, and thus, a separate additional communication channel for the fault transmission is not required, so it is possible to secure the same safety without increasing system construction costs.

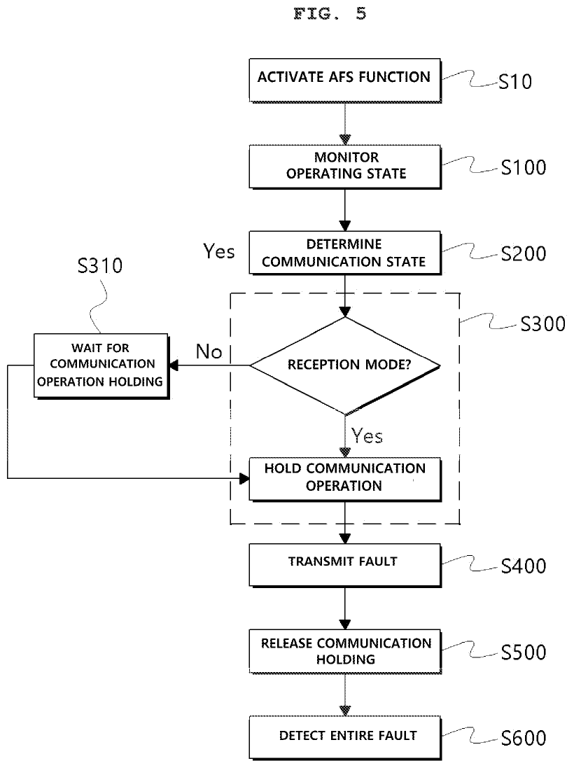

FIG. 5 is a flowchart illustrating a communication network control method according to an embodiment of the present disclosure. As illustrated in FIG. 5, the communication network control method according to the embodiment of the present disclosure preferably includes a monitoring step (S100), a state determination step (S200), a reception holding step (S300), a fault transmission step (S400), and a holding release step (S500). In this case, each step is preferably performed in one main module 100 and the plurality of sub-modules (first to N-th sub-modules 200) that constitute the communication networks (daisy chain) connected in the ring structure and operating in the half-duplex transmission mode.

In addition, the communication network control method according to the embodiment of the present disclosure is limitedly described to the battery management system (BMS) for smooth understanding, which is only an embodiment, and is applicable to the communication network that needs to actively and immediately transmit information, such as various faulty, from the slave module to the master module.

When the battery management system normally operates, as illustrated in FIG. 3, the main module 100 and the first to N-th sub-modules 200 are sequentially connected by the half-duplex communication network having a ring structure, and thus, in normal times, by using the communication control right set in the main module 100, the main module 100 sequentially transmits desired information (command information, etc.) to the first to N-th sub-modules 200 through the network in the first direction. In addition, the main module 200 receives information (response information) from at least one of the first to N-th sub-modules 200 through the network in the second direction opposite to the first direction.

in the process of performing communication, due to an activation function of a fault alert controller included in the sub-module 200, when the targeted objects (battery, etc.) connected in the sub-module 200 or the sub-modules 200 themselves fail, the corresponding sub-module 200 temporarily has the communication control right of the current network communication direction without waiting until the main module 100 changes the: network communication direction to quickly transmit the fault information (abnormality detection information, etc.) to the main module 100.

Each step is described below.

The monitoring step (S100) monitors the operating state of the connected targeted objects in each sub-module (more specifically, the BMW configured in the sub-module) 200. The operating state to be monitored by each sub-module 200 is preferably main fault information related to safety diagnosis.

In this case, when the targeted object is limited to a battery as described above, as the operating states monitored by the slab-module, the over voltage (OV), the under voltage (UV), the over temperature (OT), the under temperature (UT), or the internal fault information of the sub-module may be described as a result, but the present disclosure is not limited thereto.

In the state determination step (S200), when an abnormality in the operation states of the connected targeted objects is detected in any one sub-module 200 by the monitoring step (S100), the current communication state is determined in the corresponding sub-module 200, that is, the i-th sub-module 200.

In detail, it is preferable to determine whether the current communication state is the transmission mode (TX) or the reception mode (RX).

In the i-th sub-module 200, when the current communication state is the reception mode according to the determination result of the state determination step (S200), in the reception holding step (S300), the current communication operation is held, that is, the signals from the connected main modules 100 or the sub-modules 200 are blocked from being received.

Of course, in the communication network control method according to the embodiment of the present disclosure, as illustrated in FIG. 5, when the current communication state is the transmission mode according to the determination result of the state determination step (S200), the holding waiting step (S310) is preferably further performed.

In detail, in the holding waiting step (S310), in the i-th sub-module 200, according to the determination result of the state determination step (S200), when the current communication state is the transmission mode, the change to the reception mode waits while the current communication operation is maintained. That is, after all the transmission is completed, the reception holding step (S300) is performed after waiting until the current communication operation is changed to the reception mode, so the current communication operation is held.

However, according to the communication network control method according to the embodiment of the present disclosure, in performing the reception holding step (S300), it is confirmed in the i-th sub-module 200 that the current communication state is the reception mode, and before holding the current communication operation, when the command signal is received from the main module 100 or the signal (command signal by the main module 100 or response signal by the i-th sub-module 200) is received from another i-th sub-module 200, in other words, since the current communication state is the reception mode, the command signal of the main module 100 is received according to the communication network control situation, or a command signal transmitted from another i-th sub-module 200 first connected to the main module 100, a response signal of another i-th sub-module 200, or fault information of another i-th sub-module 200 may also be received.

In this case, after the i-th sub-module 200 confirms that the current communication state is the reception mode, and prior to holding the current communication operation, performs (generate the response signal by the command or transmit, the received signal) the response operation according to the received signal while maintaining the current communication operation, it is preferable to hold the current communication operation.

In other words, when the timing of detecting the fault in the i-th sub-module 200 and transmitting the fault information and the timing of receiving the signal from the main module 100 or another i-th sub-module 200 may be the same, a signal received through an arbitration has priority, and after all operations by the received signal are processed, the fault information is transmitted.

In the fault transmission step (S400), the i-th sub-module 200 transmits the detected fault information to the main module 100 based on the temporary control right set for the current communication direction.

That is, the i-th sub-module 200 may receive the information from the main module 100 in the first direction only under the control of the main module 100, and transmit the information in the second direction opposite to the first direction to be received by the main module 100, but when the i-th sub-module 200 is switched to the fault transmission mode, the i-th sub-module 200 transmits the fault information quickly detected by the main module 100 through the first direction without waiting until the i-th sub-module 200 is changed to the second direction, that is, without waiting until the information is transmitted to the main module 100.

In other words, as illustrated in FIG. 4, the i-th sub-module 200 switched to the fault transmission mode transmits the fault information using the first direction.

In the holding release step (S500), the i-th sub-module 200 preferably returns the current communication operation suspended by the reception holding step (S300) after the transmission of the fault information is completed.

That is, in the communication network control method according to the embodiment of the present disclosure, as soon as the fault is detected, the fault information may be immediately notified using the current main communication direction, and thus, no additional communication channel is required for fault transmission, so it is possible to secure the same safety without increasing costs.

In order to perform this operation, as illustrated in FIG. 5, it is preferable that the communication network control method according to the embodiment of the present disclosure further performs the function activation step (S10) for activating the function of the fault alert controller configured in the sub-module 200 before performing the monitoring step (S100).

The function activation step (S10) activates an active fault signaling (AFS) function in each sub-module (in more detail, the BMW configured in the sub-module) 200.

In detail, each sub-module 200 is configured to have a built-in fault alert controller for transmitting the fault information, and when the fault is detected, the fault alert controller controls to transmit the fault information in the current main communication direction.

As a result, in the communication network control method according to the embodiment of the present disclosure, when the fault is detected by the monitoring step (S100), the sub-module 200 determines that the current communication state is the transmission mode or the reception mode by the state determination step (S200), and if it is determined that the current communication state is the transmission mode, the sub-module 200 waits for until it is changed to the reception mode, and if it is determined that the current communication state is the reception mode, the sub-module 200 holds the function of transmitting the fault information from the RX to the TX by the reception holding step (S300). As a result, the transmission conflict is prevented and the fault information detected by the fault transmission step (S400) is controlled to be transmitted in the main communication direction. After the transmission of the fault information is completed, by resuming the transmission function from the RX to the TX originally by the holding release step (S500), the communication network through the normally set main communication channel is configured.

In the communication network control method according to the embodiment of the present disclosure, in some cases, two or more sub-modules 200 may perform the fault detection at a similar timing by the monitoring step (S100).

In this case, since each sub-module 200 may not know whether there is a fault in another sub-module 200, in each sub-module 200 by control, the state determination step (S200), the reception holding step (S300), the fault transmission step (S400), and the holding release step (S500) are performed.

However, when the operation is performed by the fault transmission step S400, only the fault information of the sub-module 200 closest to the main module 100 is transmitted based on the communication direction in which the fault information is transmitted. When the closest sub-module 200 is the sub-module 200 configured at the rear end, in the case of the sub-module 200 configured at the front end, even if the sub-module 200 performs the fault transmission step (S400), since the sub-module 200 configured at the rear end is holding the current communication state, which is the reception mode, while already performing the reception hold step (S300), the transmission is no longer made.

Therefore, the main module 100 receives only the fault information of the sub-module 200 closest to the main module 100 based on the communication direction mode in which the fault information is transmitted by the fault transmission step (S400).

However, in general, since the main module 100 requests the state information for all the sub-modules 200 when the fault information is received, even if the failure information of the sub-module 200 configured in the front end is not transmitted through the failure transmission step (S400) of the sub-module 200 configured in the rear end, the main module 100 may acquire the failure information of the sub-module 200 configured in the front end.

To this end, in the communication network control method according to the embodiment of the present disclosure, as illustrated in FIG. 5, after performing the fault transmission step (S400), it is preferable to further perform the failure detection step (S600).

In the fault detection step (S600), when the main module 100 transmits the fault information from the i-th sub-module 200 by the fault transmission step (S400), the main module 100 transmits the command signal requesting the current state information for the connected first to N-th sub-modules 200.

In this case, each sub-module 200 returns the current communication operation held through the holding release step (S500) immediately after the transmission of the fault information is completed by the fault transmission step (S400).

Therefore, through the fault detection step (S600), the main module 100 transmits the command signal requesting the current operating states of the first to N-th sub-modules 200 by quickly using the network in the first direction as soon as the fault information is received by the fault transmission step (S400), and the first to N-th sub-modules 200 also use the network in the second direction to transmit the current operation state by the response operation.

As described above, in the communication network control method according to the embodiment of the present disclosure, in the communication network configured in the ring structure and operating in the half-duplex transmission mode, when the major fault related to the safety diagnosis occurs, the corresponding sub-module may actively transmit the fault information to the main module without time delay, thereby securing the same system safety without configuring the separate communication channel for the fault information transmission.

According to the management system and the control method of the present disclosure, in a communication network configured in a ring structure and operating in a half-duplex transmission mode, it is possible to secure safety without increasing manufacturing costs of the system due to a communication path construction by actively quickly transmitting fault information to a main module without constructing a separate communication path for main fault information related to safety diagnosis of connected targeted objects.

In addition, since the main module quickly detects an occurrence of fault, it is possible to improve safety of the system by securing a maximum time for responding to the fault.

Although the present disclosure has been described with reference to the exemplary embodiments and the accompanying drawings, the present disclosure is not limited to the above-mentioned exemplary embodiments, modification and improvements of the disclosed exemplary embodiments and other embodiments may be made based on the disclosure in this patent document.

What is claimed is:

1. A management system, comprising;
first to N-th sub-modules for monitoring states of a plurality of targeted objects, respectively; and
a main module coupled to the first to N-th sub-modules to receive state information of the targeted object,
wherein the main module and the first to N-th sub-modules are sequentially coupled through a half-duplex communication network having a ring structure,
the main module sequentially transmits information to the first to N-th sub-modules through the network in a first direction, and the main module receives information from at least any one of the first to N-th sub-modules through the network in a second direction opposite to the first direction, and
the i-th sub-module is switched to a fault transmission mode, and transmits fault information to the main module through the network without waiting until a network transmission direction is changed to the second direction by controlling of the main module when abnormal state is detected during monitoring. (N>1, N≥i≥1)

2. The management system of claim 1, wherein the i-th sub-module determines a current communication state in a case of the fault transmission mode, and holds a current communication operation when the determined current communication state is a reception mode (RX).

3. The management system of claim 2, wherein the i-th sub-module holds the current communication operation and then transmits the fault information to the main module through the network in the first direction.

4. The management system of claim 3, wherein the i-th sub-module completes the transmission of the fault information to the main module and then returns the held current communication operation.

5. The management system of claim 1, wherein, the i-th sub-module waits for a change to the reception mode (RX) while maintaining the current communication operation when the determined current communication state is the transmission mode (TX).

6. The management system of claim 3, wherein, the main module transmits a command signal requesting current state information for the coupled first to N-th sub-modules through the network in the first direction in a case of receiving the fault information from the i-th sub-module.

7. A control method of a management system, the management system including a main module and first to N-th sub-modules configured in a ring structure and operated in a half-duplex transmission mode, the method comprising:
a monitoring step of monitoring states of coupled targeted objects, respectively, in the first to N-th sub-modules;
a state determination step of determining a current communication state when an abnormal state is detected during monitoring by the monitoring step in an i-th sub-module;
a reception holding step of holding a current communication operation according to the determination result of the state determination step in the i-th sub-module, when the current communication state is a reception mode (RX);
a fault transmission step of transmitting fault information detected by the monitoring step through a network in a first direction between the main module and the plurality of sub-modules in the i-th sub-module; and
a holding release step of returning the current communication operation held by the reception holding step in the i-th sub-module. (N>1, N≥i≥1)

8. The control method of claim 7, further comprising:
an activation step of activating an active fault signaling (AFS) function in the i-th sub-module before performing the monitoring step.

9. The control method of claim 7, further comprising:
a holding waiting step of waiting for a change to a reception mode while maintaining a current communication operation according to the determination result of the state determination step in the i-th sub-module, when the current communication state is a transmission mode (TX) after performing the state determination step.

10. The control method of claim 7, wherein, the current communication operation is held after performing a response operation according to the received command signal while maintaining the current communication operation when a command signal is received from the main module before holding the current communication operation through the reception holding step.

11. The control method of claim 7, wherein, the current communication operation is held after performing a transmission operation according to the received signal while maintaining the current communication operation when a signal is received from another i-th sub-module before holding the current communication operation through the reception holding step.

12. The control method of claim 7, wherein, when abnormal states of targeted objects connected in two or more sub-modules, respectively, are detected in the monitoring step, in each sub-module, the state determination step, the reception holding step, the fault transmission step, and the holding release step are performed by control, but, in the main module, fault information of a sub-module closest to the main module is received based on a communication direction mode in which the fault information is transmitted by the fault transmission step.

13. The control method of claim 12, further comprising:
a fault detection step of transmitting a command signal requesting current state information for the connected first to N-th sub-modules in the main module when the fault information is received from the i-th sub-module by the fault transmission step after performing the fault transmission step.
